(19) United States
(12) Patent Application Publication
(10) Pub. No.: US 2012/0327256 A1
(43) Pub. Date: Dec. 27, 2012

(54) Headwear with Visual Indication

(75) Inventors: Zoe Robson, London (GB); Leona Dean, London (GB)

(73) Assignee: SOUTH BANK UNIVERSITY ENTERPRISES LTD, London (GB)

(21) Appl. No.: 12/300,032

(22) PCT Filed: May 11, 2007
(86) PCT No.: PCT/GB07/01735

§ 371 Date: Sep. 11, 2009

(30) Foreign Application Priority Data
May 11, 2006 (GB) 0609316.5
Oct. 2, 2006 (GB) 0619416.1

(51) Int. Cl. H04N 5/225; A41D 19/00; H04N 5/232; A63B 33/00

(52) U.S. Cl. 348/211.99; 2/431; 2/160; 348/376; 348/E05.042; 348/E05.024

(57) ABSTRACT

A preferred embodiment of the present invention relates to headwear (1). The headwear comprises a frame (3) mountable on a user's head, and an imaging device (9). The imaging device (9) has a first field of view defining a portion of the surrounding environment of which an image may be captured, and the item of headwear includes means (15) for providing a visual indicator of said first field of view to thereby provide a user wearing said headwear with a visual indication of the portion of the surrounding environment of which an image may be captured with said imaging device. The headwear may comprise a substantially transparent viewing portion (5) supported by the frame so as to be located in front of the user's eyes when the headwear (1) is worn by the user, and in another embodiment headwear is disclosed that is configurable to implement limited zoom functionality. In yet another embodiment an imaging system including the headwear is disclosed.

### FIELD OF THE INVENTION

This invention relates to headwear. Particularly preferred embodiments of the present invention relate to headwear that incorporates an imaging device, and other embodiments relate to an imaging system that includes such headwear.

### BACKGROUND TO THE INVENTION

As the popularity of extreme sports has increased, it has become more common for participants to want to capture images of their immediate environment whilst they are partaking of their particular sport.

For example, underwater divers have been known to carry underwater camera equipment so that they can take photographs whilst they are underwater. Such equipment varies from, on the one hand, complex (and hence expensive) dedicated underwater imaging equipment that is specially designed to prevent water ingress; to, on the other hand, relatively simple (but still relatively expensive) watertight containers within which a normal camera can be sealed, the container enabling the camera to be operated whilst sealed therein. One example of such a container is the SONY¹ MPK-NA which is specially designed for use with the SONY Cybershot¹ Digital Still Camera DSC-N1.

¹Sony and Cybershot are registered trademarks of Sony Corporation, Japan

One problem with such arrangements is that they are at best inconvenient to use, and at worst potentially dangerous. For example, a diver concentrating on taking a photograph has no vision of their immediate environment outside of what they can see through the viewfinder of the camera and as such the diver's ability to perceive approaching dangers is greatly curtailed.

In addition, by encasing a camera within a protective housing, the diver then has to look through several transparent layers before they can determine exactly what image the camera is able to capture, and as a consequence it can be difficult to correctly line up the camera—particularly if the diver is also trying to tread water at the same time. Another problem with such proposals is that they require a significant amount of set-up time before an image can be taken. For example, a diver who sees a particular fish that they would like to photograph has to locate their camera, correctly line up the camera, and then take the Photograph—by which time it is not uncommon for the fish to have swum away.

It has also previously been proposed, for persons partaking of other sports, to mount a separate camera to their headwear. For example, it has been proposed to film a skier's activities by mounting a video camera to the side of the skier's helmet, which camera is then wired to a storage device carried in a backpack by the skier. It has even been known for skiers or snowboarders to travel down a mountain whilst holding a camera.

Skiing or snowboarding whilst holding a video camera is not preferred as it is easy for the equipment to be damaged, and it is difficult for the user to accurately determine exactly what image is being captured without looking through the viewfinder of the camera.

As regards the proposal to externally mount a camera to the user's headwear, it will be apparent that whilst such a configuration is easier for the user to use, the user still has only a rough appreciation of what it is that the camera is capturing. Furthermore, the exposed location of the camera on the helmet means that it is relatively easy for the camera to be dislodged (either by being struck, or simply by the force of the wind flowing over the camera as the skier travels down the slope), following which images captured by the camera will most probably bear no relation to the images being seen by the user.

Yet another problem is that as the field of view provided by the headwear is typically larger than that provided by the camera, it is relatively difficult for the user to properly position the camera with respect to the particular feature or features of the outside environment that they wish to photograph.

It is apparent, therefore, that it would be beneficial if an item of headwear could be devised that avoids or at least mitigates one or more of the aforementioned problems.

### SUMMARY OF THE INVENTION

To this end, a presently preferred embodiment of the invention provides an item of headwear comprising: a frame mountable on a user's head, and an imaging device having a first field of view defining a portion of the surrounding environment of which an image may be captured, said item of headwear including means for providing a visual indicator of said first field of view to thereby provide a user wearing said headwear with a visual indication of the portion of the surrounding environment of which an image may be captured with said imaging device.

The headwear may further comprise a substantially transparent viewing portion supported by the frame so as to be located in front of the user's eyes when the headwear is worn by the user.

In a particularly preferred embodiment the imaging device is mounted in the frame.

By virtue of the aforementioned arrangements, the user is provided with a headwear mounted imaging device where the user is better able to determine exactly what image it is that they are capturing when the imaging device is operated. It is also the case that by mounting the imaging device in the frame, it is possible to reduce the likelihood of the device being damaged or dislodged in use.

In a preferred embodiment, the headwear may comprise means for adjusting the positioning of said imaging device relative to said viewing portion. This arrangement permits the field of view to be re-aligned with that indicated by the visual indicator in the event that the position of the imaging device with respect to the viewing portion should be altered.

Preferably, the visual indicator is provided in or on said viewing portion. For example, the visual indicator may be printed (or otherwise deposited) on a surface of the viewing portion. In another arrangement, visual indicator may be embedded within the viewing portion. This latter arrangement serves to better protect the visual indicator from damage.

The visual indicator may be configured to be more visible when illuminated, the headwear comprising means for illuminating said indicator. By virtue of this arrangement it is possible to provide an indicator which does not adversely affect the user's view through the viewing portion until the illumination means is operated. In a preferred embodiment the visual indicator may be configured to be more visible when illuminated with light of a particular range of wavelengths, and the illuminating means may be configured to generate light having said particular range of wavelengths (for example, UV light).

In one preferred embodiment, the viewing portion may comprise a plurality of visual indicators. Each of said visual indicators may define a field of view that is different to those defined by the remaining visual indicators. In this embodiment, the imaging device may be configured to implement limited zoom functionality by adjusting said imaging device to have a field of view for each of the plurality of views defined by said visual indicators. For example, the imaging device may comprise one or more lenses and an image capture device, and changes in the imaging device field of view may be accomplished by relative movement between one or more of said lenses and said image capture device.

In a preferred arrangement the imaging device comprises a controller that is operable to control the operation of said imaging device. The imaging device may further comprise an input/output interface, such as a wireless input/output interface, for outputting captured image data to a remote control unit and for receiving control signals from said control unit.

The frame may be attachable to a user's head by means of a strap or other securing device passed round the circumference of the user's head. Alternatively or additionally, the frame may comprise a helmet.

Another aspect of the present invention relates to an imaging system comprising: an item of headwear as described herein; a controller configured to receive signals from a user-operable actuator and to act on said signals to generate control signals for controlling said imaging device to capture an image, and storage for receiving and storing images captured by said imaging device.

In one embodiment the controller, actuator and storage are located in a control unit remote from said headwear. In another embodiment the controller and storage are located in a control unit remote from said headwear, and said actuator is remote from both said control unit and said headwear.

In a particularly preferred embodiment the control unit and headwear each comprise a wireless communications interface to thereby enable wireless communications between said control unit and said headwear. In another arrangement the actuator may comprise a wireless communications interface to thereby enable wireless communications between said actuator and said control unit.

In a particularly preferred arrangement the actuator may be carried by an item of said user's clothing, for example a glove. This arrangement is advantageous as the actuator is then readily accessible for user operation of the system.

Another aspect of the present invention relates to a glove for use with the system described herein, the glove having an actuator fixedly attached thereto, said actuator being user operable to generate control signals for control of said controller and/or said imaging device. Yet another aspect of the present invention relates to a remote control unit for the system described herein, the control unit comprising a communications interface for transmitting signals to the headwear and for receiving data therefrom, a storage device for storing data received from the headwear and a controller for controlling the control unit and for generating control signals for controlling the imaging device on operation of the actuator by the user.

Various other features and advantages of embodiments of the present invention will be immediately apparent to persons of ordinary skill in the art from the following detailed description of embodiments of the invention.

### BRIEF DESCRIPTION OF THE DRAWINGS

Presently preferred embodiments of the present invention will now be described with reference to the accompanying drawings, in which:

FIGS. 1a, 1b and 1c are illustrative front, side and plan views (respectively) of an item of headwear in accordance with a presently preferred embodiment of the present invention;

FIG. 2 is a schematic depiction of the components of the imaging device of the headwear shown in FIG. 1;

FIG. 3 is an illustrative representation of a modification of the headwear depicted in FIG. 1a;

FIG. 4 is a schematic representation of an imaging system incorporating the headwear of FIG. 1;

FIG. 5 is a modification of the system depicted in FIG. 4; and

FIG. 6 is an illustrative representation of an actuator for the system of FIG. 5.

### DETAILED DESCRIPTION OF PREFERRED EMBODIMENTS

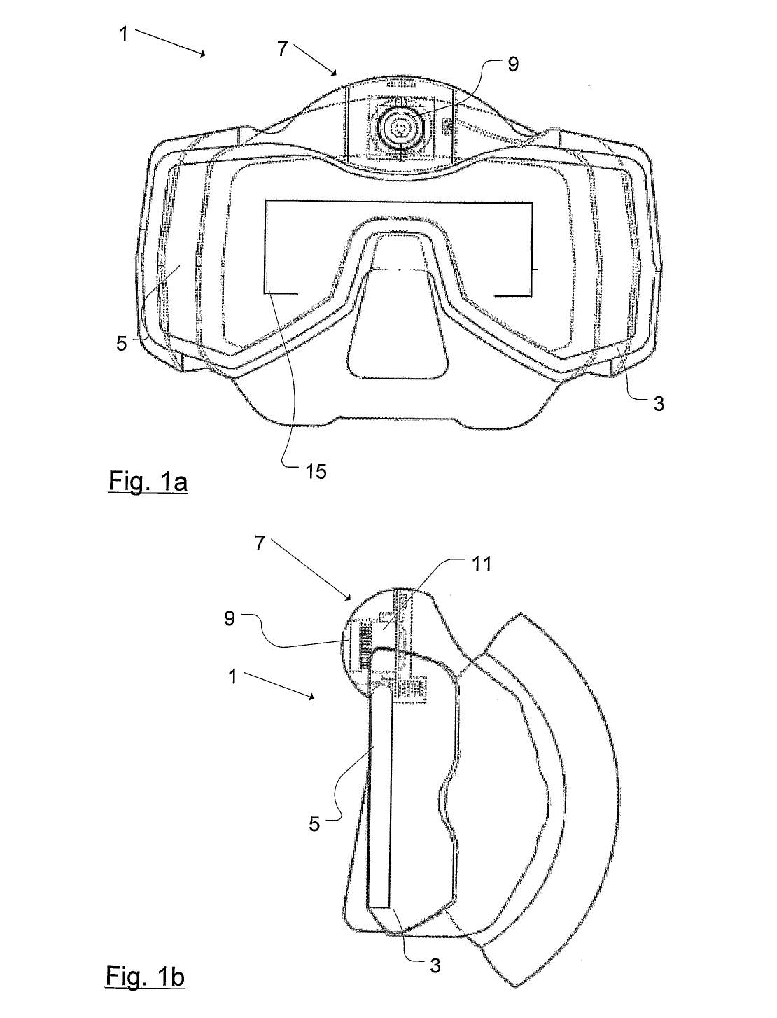

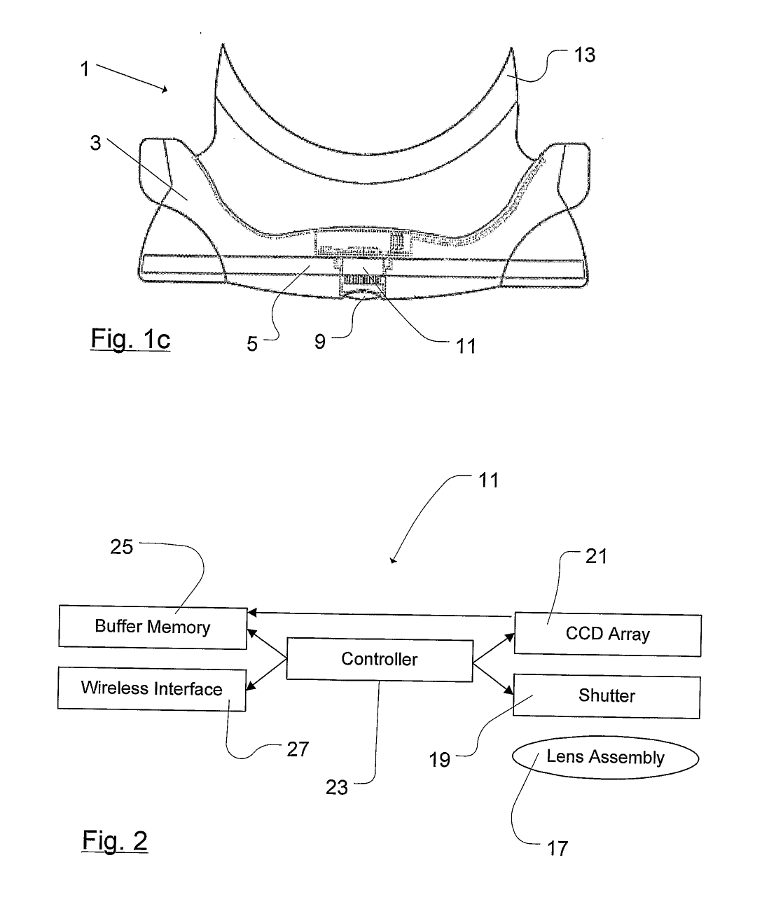

FIG. 1a is a front elevation of an item of headwear in accordance with a preferred embodiment of the present invention. In this particular example, the headwear comprises a mask 1 of the type that a diver might use. However, it will be apparent, and should be noted, that the teachings of the present invention may be applied to a variety of different types of headwear. For example, the headwear could comprise a helmet, such as a helmet that a skier or motor racing driver might wear. The teachings of the present invention are also not limited to use of the headwear in connection with sporting activities, and could equally be applied to items of safety wear such as helmets that fire safety professionals might use.

The headwear is also not limited to items that include transparent (or at least translucent) plates through which a user views the surrounding environment. Rather, the teachings of the present invention are equally applicable to headwear (such as a climber's or cyclist's helmet for example) that does not include such a transparent plate.

As shown in FIG. 1, the facemask 1 of this embodiment includes a frame 3 which supports a plate 5 through which a user of the mask can view their immediate surroundings. Depending on the application that the headwear is to be used for, the plate may not necessarily be provided. If, as in this embodiment, a plate is provided it may be transparent or translucent, and may also be tinted.

The frame 3 includes an expanded portion 7 that includes an internal void (not shown) which opens to outside via an aperture 9 that is located—in this embodiment—above and in between the user's eyes when the headwear is worn. The void, as will later be described, houses an imaging device 11 that is operable by a user to capture an image of a portion of the exterior environment surrounding the user.

To prevent water ingress, the imaging device may be sealed within the void by a transparent plate that closes the aperture 9. Alternatively the imaging device 11 may itself be sealed from water ingress, in which case the aperture in the frame does not need to be sealed. The imaging device may, as will be later be described, comprise a camera (for example a digital camera) configured to capture individual still images, or it may comprise a video camera configured to capture a video image. The imaging device may also be a digital still camera that is capable of operating in a video mode to capture relatively short video sequences. The imaging device may be configured to operate as a conventional camera or video camera, or in an alternative configuration the imaging device may be configured (again in a manner well known to persons of ordinary skill in the art) to function in a night vision mode.

In the example illustrated in the drawings, the frame 3 includes a valance 13 of rubber or other resiliently flexible material that is designed to form a seal about the user's face to thereby avoid water ingress into the void between the user and the plate 5. An elastic retainer (not shown) is coupled to either side of the frame to permit the headwear to be secured on a user's head.

As explained earlier, a significant problem associated with previously proposed arrangements is that the user has no real perception of what the imaging device is actually capable of capturing when the user decides to capture an image. To alleviate this problem, in one embodiment the plate 5 is provided with a visual indicator 15 that defines a field of view which is coincident, or at least substantially coincident, with the field of view of the imaging device 11. In other words, the positional relationship of the imaging device and the frame is carefully controlled so that the field of view of the imaging device 11 is at least substantially the same as, preferably exactly the same as, the field of view defined by the visual indicator 15.

The visual indicator may simply comprise, as indicated, a line printed or otherwise formed in or on a surface of (preferably an inner surface of) the plate 5. In a preferred embodiment, the indicator may be configured to be more visible when illuminated by light of a particular band of wavelengths, for example UV light, from one or more light emitting diodes or other suitable light sources (not shown) located within the headwear and configured to illuminate the visual indicator.

In a highly preferred embodiment the imaging device is mounted in the frame by means of a moveable mounting that enables the imaging device to be moved in X and Y planes and tilted with respect to the plate so that the position of the imaging device field of view can be adjusted, if necessary, to be at least substantially the same as the field of view defined by the visual indicator 15.

Referring now to FIG. 2, the imaging device 11 comprises a lens assembly 17 consisting of one or more optical lenses, a shutter 19 and an image capture device such as a CCD (charge coupled device) array 21. The shutter and array are controlled by a controller 23 that is responsive to an activation signal generated in response to user activation of the imaging device to open the shutter for the capture of an image by the CCD array. In a particularly preferred arrangement the controller is operable to implement (in a known manner) an autofocus function whereby the optics are moved to focus on the subject being photographed. In another arrangement, the controller may be operable to implement an autofocus function of the well known type previously proposed for digital cameras where the position of the optics with respect to the CDD is fixed.

Once an image has been captured, the controller closes the shutter 19 and controls the image capture device 21 to output the stored image to a buffer memory 25 that provides transient data storage whilst the data is output via an I/O (input/output) interface 27 to a remote storage device that will later be described. In a highly preferred embodiment the interface 27 comprises a wireless interface, for example a wireless Bluetooth® interface or other short range wireless communications interface, but it will be appreciated that the connection between the imaging device and remote data store may instead be provided by means of a wired connection. The imaging device includes a power source (not shown), for example a rechargeable battery, which powers the controller, CCD array, shutter controller, memory and interface. In a highly preferred arrangement access to said power source is only achievable from inside the headwear, thereby reducing the likelihood of water ingress into the power source.

Although not shown in the figures, the frame may include one or more light sources (for example LED or other suitable light sources) which can be energised in low light levels (for example in the manner of a flash) to illuminate a subject that the wearer of the headwear wishes to photograph. The light sources may be user-operable, or in an alternative arrangement they may be configured to automatically illuminate (in a manner well known in the art) in the event of detected low levels of ambient light when a user attempts to capture an image. In a particularly preferred arrangement the light sources may be activated independently of the imaging device in the manner of a torch. In another arrangement, the headwear may be configured to interface with a discrete lighting element, for example a separate flash light of the type that divers might carry. In such an arrangement the flash light may be linked by a wired or wireless connection to the headwear or any other component of the system of which the headwear forms part and may be configured to flash illuminate the subject on operation of the headwear by a user to capture an image.

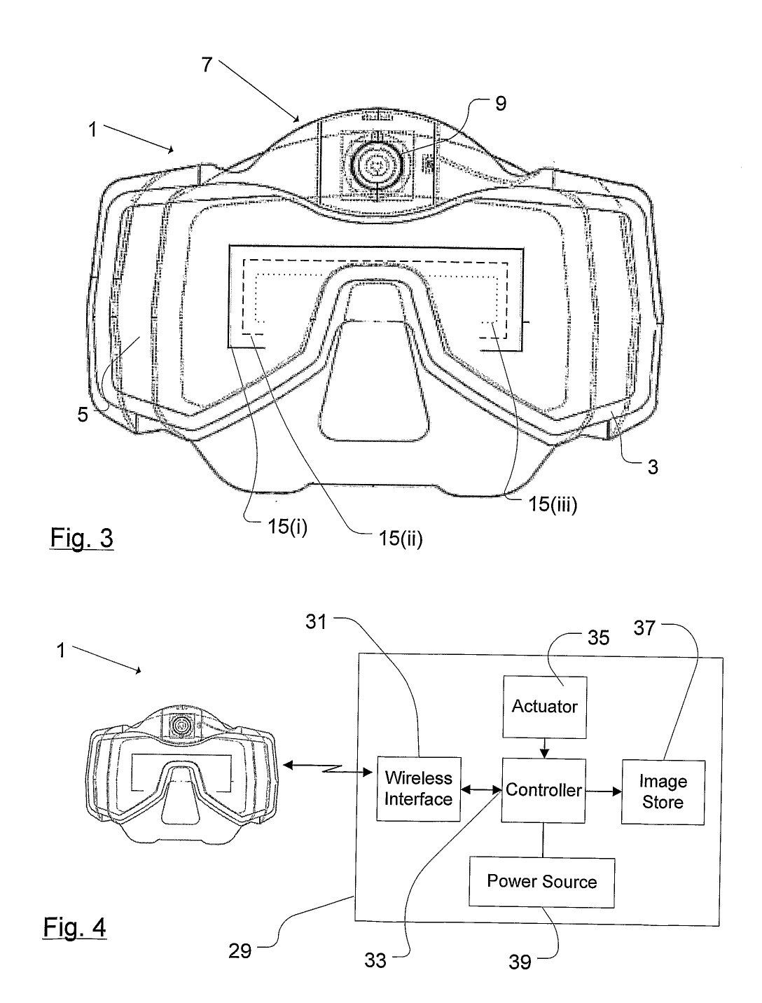

Referring now to FIG. 3, the imaging device may be configured to provide a limited zoom function by enabling the imaging device field of view to be adjusted between preset positions. In this scenario, the plate includes a plurality of visual indicators (in this instance three indicators are provided, labelled 15(i), 15(ii) and 15(iii))—each of which corresponds to a given zoom amount. In the particular example illustrated in the drawings, indicator 15(i) corresponds to a normal field of view for the imaging device (i.e. zero zoom), indicator 15(ii) corresponds to a first zoom level that has a reduced field of view (as compared to the normal field of view), and indicator 15(iii) corresponds to a second higher zoom level which has a further reduced field of view (as compared to the reduced field of view associated with the first zoom level). The imaging device is configured to step between the normal and zoom field of views in response to command signals generated by user operation of the device (in a manner that will later be described).

As will be appreciated by persons skilled in the art, greater or fewer numbers of zoom levels and associated visual indicators may be provided, and the zoom function itself may be provided by means of an optical zoom (i.e. a zoom accomplished by moving the lens with respect to the CCD array), or a digital zoom (a zoom accomplished by generating an image from only a portion of the CCD array). Where possible, optical zooms are preferred as such arrangements allow a zoom function to be implemented without affecting the resolution of the final image.

FIG. 4 is a schematic representation of an imaging system that comprises an item of headwear 1 as described above, and a remote control unit 29. The remote control unit 29 comprises a wireless interface 31 that is configured to communicate wirelessly for signal transmission and reception with the wireless interface 27 of the imaging device 11. As previously mentioned, this wireless interface could be replaced with a wired connection if desired.

The wireless interface 31 is coupled to a controller 33 that is operable to control the interface 31 and to generate command signals in response to operation of an actuator 35 by the user. The controller is also coupled to an image store 37 in which image data received via the wireless interface 31 from the imaging device 11 may be stored. The image store may comprise any one of a number of different storage devices. For example, the image store may comprise solid state memory, for example in the form of a memory card or stick, or a so-called microdrive. Where the storage comprises solid state memory, data may be downloaded by removing the storage device and plugging it into another computer. Alternatively, download of data may be accomplished via the wireless interface, or by means of a USB connector coupled to an appropriate interface (not shown) provided in the body of the remote control unit. Clearly, for an underwater application, it would be preferred for data download to occur via the wireless interface in order to avoid the potential for damage by water ingress.

The remote control unit 29 further comprises a power source 39 for powering the controller, interface, image store and—if required—the actuator. The actuator, imaging device and remote control unit may each include an on/off switch to enable the devices to be switched off when not in use to conserve battery power. Alternatively, the remote control unit and imaging device may be configured to have a low-power standby mode that may be invoked by the user on operation of an appropriate control provided on the actuator.

In an envisaged implementation, particularly suitable where the imaging device is mounted in a diver's mask, the remote control unit may be configured to be integrated into a standard diver's buoyancy device, for example by configuring the device as a module that can be clipped onto the diver's buoyancy belt or jacket.

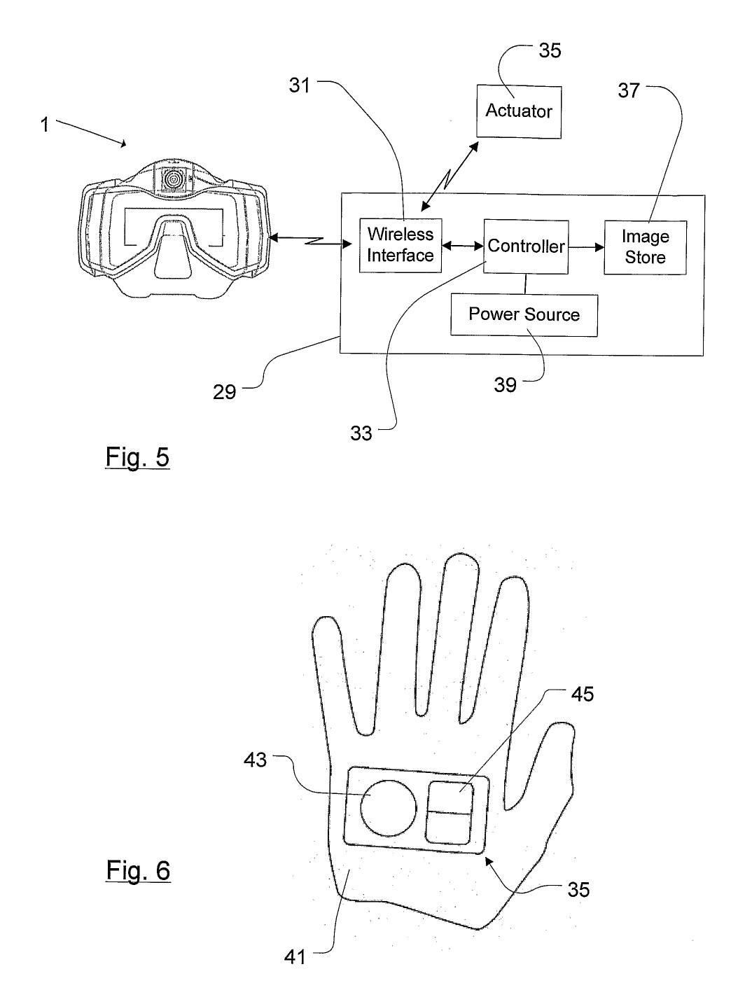

In a modification of the arrangement depicted in FIG. 4 (as shown in FIG. 5), the actuator 35 may be wirelessly coupled to the remote control unit 29, and in this arrangement the actuator may be placed within convenient reach of the user whilst the remainder of the device controller is carried in a less accessible position. In this implementation the actuator would also comprise a wireless interface and power source (such as a rechargeable battery), but for clarity these elements have been omitted from the figures. Again, it will be appreciated by persons skilled in the art that a wired connection between the actuator and the interface may instead be provided.

Referring now to FIG. 6, the actuator 35 could be carried on the back of a user's glove 41 (or any other item of clothing worn by the user), and in this implementation the actuator may comprise a button 43 that can be pressed by a user to instruct the imaging device (via the controller 33) to capture an image as well as a toggle switch 45 that can be switched in one direction to increase the zoom of the imaging device and in the other direction to reduce the zoom of the imaging device. Additional switches and buttons may be provided, as required, to instruct the remote control device controller to implement other functionality. Optionally, the actuator may take any other convenient form. For example, the actuator could be mounted on a baton that is configured to be held in the hand of a user.

The remaining components of the remote control unit could be configured as a belt-mountable module, and the glove would provide the user with a particularly convenient means to operate the imaging system.

To operate the device to capture an image, the user presses a button or other input device on the actuator and a signal is sent to the controller of the device control unit. The controller of the remote control unit receives the signal from the actuator input device and sends (via the wireless interface, or via a wired connection) a “capture image” signal to the controller of the imaging device. On receipt of the “capture image” signal, the controller signals the shutter to move to an open configuration and the CCD array to store an image. The controller then closes the shutter and controls the CCD array to transfer the image via the buffer memory (if required) and the wireless interface to the remote control unit. The controller of the remote control unit, on receipt of image data from the imaging device, transfers the data to the data storage device for storage therein.

In a similar way, if the user should manipulate controls on the actuator to effect a zoom mode, the remote control unit controller issues an “increase zoom” or “decrease zoom” signal, as appropriate, to the imaging device, following which an image can be captured in the manner detailed above.

It will be appreciated that whilst certain presently preferred embodiments of the present invention have been described herein, modifications and alterations may be made to those embodiments without departing from the scope of the present invention as defined by the accompanying claims.

For example, the remote control unit may carry a display screen for displaying relevant information to the user. Relevant information may include, inter alia, the number of photographs that may still be captured, the status of one or more of the batteries, or (in the context of a system for use whilst diving) details of the dive profile for the particular dive that the user is undertaking.

It is also conceivable for the plate 15 to include a portion that is configured as a display (such as an LCD (liquid crystal display)) by means of which a captured image or other information can be displayed to the user. The remote control unit may also be configured to display control information to the user, for example to display menus of items that are user selectable by means of the actuator to vary the manner in which the system operates. In another arrangement, the plate or other components of the headwear may carry a means for conveying information to the user. For example, it is conceivable that the frame may carry one or more light emitting diodes (LEDs) which can be lit to convey information to the user. In a particularly preferred arrangement, a green light source may be lit whilst the battery has sufficient stored power to operate the system or there is sufficient space in the storage for a predetermined number of photographs, and this lit green source may be replaced by a red lit source if the power or the number of photographs that may be stored should drop below predetermined threshold levels.

In one preferred embodiment, the plate may carry an LCD (or other viewing device) which is operable to display information to the user. For example, the LCD may display the aforementioned visual indicator and regions of the external environment surrounding the indicator. In another arrangement the LCD may display only the visual indicator and that portion of the external environment which falls within the visual indicator, and in yet another arrangement the visual indicator may be omitted so that the LCD displays only that portion of the external environment which falls within the camera's field of view.

In another modification, the viewing device may be mounted on the headwear so as to be in close proximity to one of the user's eyes in use, the display screen displaying the external environment falling within the visual indicator, the visual indicator and the external environment falling therewithin, the external environment with the visual indicator superimposed thereon or any other information. In this arrangement the user's other eye has a view of the external environment, and that view may be unrestricted or may be through a plate of the type previously described.

In a preferred arrangement particularly for use in the context of a system for use whilst diving, the imaging device power source, actuator power source and remote control unit power source may be configured to be rechargeable by means of inductive coupling with a suitable power supply. This is particularly preferred as the components, which will have been sealed against water ingress, do not then need to be opened for recharging the batteries therein.

In another conceived arrangement, the image store may be located within the imaging device, and preferably accessed via the inside of the headwear.

As aforementioned, the teachings of the present invention are applicable to a variety of different types of headwear, not solely to masks for diving. For example, the imaging device could be installed in a motor racing, skiing or climbing helmet (in which case the helmet would be the “frame” described above), or in a pair of sunglasses (in which case the frame would only extend partway around the circumference of the user's head) or any other means for supporting the imaging device on the user's head. The teachings of the present invention could also usefully be employed in protective headwear for the emergency services, or indeed in a variety of different applications too numerous to list here.

It is also the case that whilst it is preferred for the imaging device to be mounted in the frame of the headwear, this is not an essential feature of the invention. Rather, the imaging device could instead be mounted to the inside of the viewing plate.

In another arrangement, the imaging device could be mounted to any component of the headwear other than the frame. For example, the imaging device could be mounted to an inner surface of the viewing plate, so that images may be captured by the imaging device through the plate. It is also conceivable for the imaging device to be mounted elsewhere than on the headwear, and for the image captured to be displayed by the headwear. For example, the imaging device could be coupled to the headwear (for example by means of a fibre optic or wireless connection) to a display that is configured to display images to the user. In this arrangement the imaging device would provide a substantially continuous flow of images to the user, those images indicating to the user what aspects of the external environment currently fall within the camera's field of view. In this instance the aforementioned zoom function may not necessarily be limited to step-changes between levels of zoom, but could instead be substantially continuously variable between lowest and highest zoom levels.

In another arrangement, the headwear may comprise a projector operable to project (in a similar manner to a head-up-display) a viewable representation of the visual indicator, or any other information, onto the plate.

Lastly it should be noted that whilst the accompanying claims present certain combinations of features herein described, it should be noted that the present invention is not limited to those combinations, but instead extends to any combination of features herein described irrespective of whether or not that combination has been claimed at this time.

1. A diver's facemask comprising:
a frame mountable on a user's head in front of a user's eyes to define a void between the frame and the user's head when the facemask is in use, the frame further comprising an internal void that opens to outside via an aperture that is located generally above and between the user's eyes;
a resilient valence provided about the periphery of the frame, the valence being configured to seal about the user's face to avoid water ingress into the void between the frame and the user's head when the facemask is in use;
a securing device locatable round at least part of the circumference of the user's head to secure the frame to the user's head;
a substantially transparent viewing portion supported by the frame so as to be located in front of the user's eyes when the facemask is worn by the user;
a digital camera sealed within the internal void in the frame by a transparent plate that closes said aperture, wherein the digital camera is arranged to capture still or video images of the surrounding environment through said plate and includes an internal solid state storage device for the storage of captured images; and
one or more light emitting diodes carried by the frame;
wherein the one or more light emitting diodes can be lit to convey information to the user of the facemask, the digital camera haste a first field of view through said transparent plate that defines a portion of the surrounding environment of which an image may be captured, and said substantially transparent viewing portion has provided therein or thereon a visual indicator of said first field of view to thereby provide a user wearing said facemask with a visual indication of the portion of the surrounding environment of which an image may be captured with said digital camera.

2.-5. (canceled)

6. A facemask according to claim 1, comprising means for adjusting the positioning of said digital camera relative to said transparent viewing portion.

7. (canceled)

8. A facemask according to claim 1, wherein the visual indicator is configured to be more visible when illuminated, the facemask comprising means for illuminating said indicator.

9. A facemask according to claim 8, wherein said visual indicator is configured to be more visible when illuminated with light of a particular range of wavelengths, said illuminating means being configured to generate light having said particular range of wavelengths.

10. A facemask according to claim 1, wherein said viewing portion comprises a plurality of visual indicators.

11. (canceled)

12. A facemask according to claim 10, wherein said digital camera is configured to implement limited zoom functionality by adjusting said digital camera to have a field of view for each of the plurality of views defined by said visual indicators.

13. (canceled)

14. A facemask according to claim 1, wherein the digital camera comprises a controller that is operable to control the operation of said digital camera.

15. A facemask according to claim 14, wherein the digital camera further comprises an input/output interface for outputting captured image data to a remote control unit and for receiving control signals from said control unit.

16. (canceled)

17. (canceled)

18. An imaging system comprising: a facemask according to claim 1; a controller configured to receive signals from a user-operable actuator and to act on said signals to generate control signals for controlling said digital camera to capture an image, and storage for receiving and storing images captured by said digital camera.

19. A system according to claim 18, wherein the controller, actuator and storage are located in a control unit remote from said facemask.

20.-23. (canceled)

24. A glove configured for use in the system according to claim 18, wherein the glove has said actuator fixedly attached thereto, said actuator being user operable to generate control signals for control of said controller and/or said digital camera.

25. A remote control unit configured for use in the system of claim 18, the control unit comprising a communications interface for transmitting signals to the facemask and for receiving data therefrom, a storage device for storing data received from the facemask and a controller for controlling the control unit and for generating control signals for controlling the digital camera on operation of the actuator by the user.

26. (canceled)

27. (canceled)

28. A facemask according to claim 1, wherein said visual indicator defines a field of view of the surrounding environment.

29. A facemask according to claim 28, wherein the visual indicator defines a field of view which is at least substantially coincident with the field of view of the digital camera.

30. A facemask according to claim 28, wherein said visual indicator is visible in use by both eyes of the user.

31. A facemask according to claim 1, wherein said visual indicator comprises a line formed in or on a surface of the substantially transparent viewing portion.

32. A facemask according to claim 15, wherein said input/output interface comprises a wireless input/output interface.

33. A diver's facemask comprising:
a frame mountable on a user's head in front of a user's eyes to define a void between the frame and the user's head when the facemask is in use, the frame further comprising an internal void that opens to outside via an aperture that is located generally above and between the user's eyes;
a resilient valence provided about the periphery of the frame, the valence being configured to seal about the user's face to avoid water ingress into the void between the frame and the user's head when the facemask is in use;
a securing device locatable round at least part of the circumference of the user's head to secure the frame to the user's head;
a substantially transparent viewing portion supported by the frame so as to be located in front of the user's eyes when the facemask is worn by the user;
a digital camera sealed within the internal void in the frame by a transparent plate that closes said aperture, wherein the digital camera is arranged to capture still or video images of the surrounding environment through said plate and includes an internal solid state storage device for the storage of captured images; and
one or more light emitting diodes carried by the frame;
wherein:
the one or more light emitting diodes can be lit to convey information to the user of the facemask,
the digital camera has a first field of view through said transparent plate that defines a portion of the surrounding environment of which an image may be captured, and
said substantially transparent viewing portion has a visual indicator of said first field of view formed in or on a surface of the substantially transparent viewing portion to thereby provide a user wearing said facemask with a real-time visual indication of the portion of the surrounding environment of which an image may be captured with said digital camera.
